(19) United States
(12) Patent Application Publication
(10) Pub. No.: US 2005/0173846 A1
(43) Pub. Date: Aug. 11, 2005

(54) Process and apparatus for the production of polyurethane moldings

(76) Inventors: Jurgen Wirth, Koln (DE); Ingo Kleba, Konigswinter (DE)

Correspondence Address: BAYER MATERIAL SCIENCE LLC, 100 BAYER ROAD, PITTSBURGH, PA, 15205, US

(21) Appl. No.: 11/049,849

(22) Filed: Feb. 3, 2005

(30) Foreign Application Priority Data
Feb. 7, 2004 (DE) 102004006074.6

(51) Int. Cl. B29C 45/00

(52) U.S. Cl. 264/572; 264/240; 425/543; 264/85; 425/546

(57) ABSTRACT

The invention relates to a process for the production of polyurethane moldings by the reaction-injection-molding process, in which at least one isocyanate component and at least one polyol component are delivered in metered manner into a mixing chamber, are mixed in the mixing chamber to form a polyurethane reaction mixture and the polyurethane reaction mixture is then discharged via a runner into the cavity of a mold, characterized in that a pressure is exerted on the polyurethane reaction mixture in the cavity by means of a pressure medium, which pressure is sufficiently high for defects, which arise by reactive and/or thermal shrinkage, and/or entrapped air pockets to be closed, wherein the pressure medium is introduced into at least one overflow cavity hydraulically connected with the cavity, and/or is introduced into the runner.

### FIELD OF THE INVENTION

The invention relates to a process for the production of polyurethane moldings by the RIM process, in which defects arising due to reactive and/or thermal shrinkage, and/or entrapped air pockets are eliminated by exposing the polyurethane reaction mixture in the cavity to pressure with a pressure medium.

### BACKGROUND OF THE INVENTION

When producing compact or also microcellular moldings, coatings or similar products from reactive resins, for example based on polyurethane, by the RIM process (reaction injection molding), in which the reactive resin is injected into the closed mold, it is necessary, by application of holding pressure, to avoid or compensate the defects (or “sink marks”) which arise by reactive and thermal shrinkage and the entrapped air or gas bubbles which occur while the resin is flowing into the mold cavity. This applies in particular to applications where the moldings are visible, for example, in automotive interior and exterior applications.

Various approaches have in the past been proposed to solve this problem, some of which have also been put into practice.

The most frequently implemented solution consists in loading one or more of the starting components of the reactive system with air or another gas, which is known as gas loading. Once the components have been mixed and the reaction mixture injected into the closed mold (the mold cavity here generally being virtually or completely filled volumetrically), the dissolved or finely dispersed gas attempts to expand and in this manner produces cavity pressure which counteracts shrinkage and limits or reduces the extent of trapped air or the occurrence of relatively large bubbles. The pressure here declines over time. The disadvantage of this approach is that only limited pressure can be produced. Moreover, once the reaction mixture has been injected, the holding pressure can no longer purposefully be varied. In addition, gas loading is not possible with transparent reactive resins as the fine bubbles produced by gas loading produce a negative visual impression and result in turbidity of the molding.

Apart from this “internal holding pressure” approach, various processes have also been proposed in which “external holding pressure” is to be exerted on the molding.

EP-A-0 024 610, for example, describes molds with resilient mold walls, the shape of which is modified by a pressure medium once the reactive mixture has been introduced. This apparently good idea has, however, not proved successful in practice as it is difficult to provide uniform temperature control of the resilient zones of the wall. The decisive shortcoming, however, is that the dimensional stability of the moldings is not sufficiently reproducible due to process-relevant tolerances, such as for example tolerances in shot weight, in the mold cavities and variable flash at the parting line, which means that this method is unacceptable, in particular for industrial moldings.

The same patent also describes an apparatus with which the reaction mixture is stored during filling of the mold cavity and, after completion of the shot, is reintroduced under pressure into the mold cavity by means of a separate piston unit.

However, this apparatus too has not proved successful in practice as, especially with thin-walled, large-area moldings, holding pressure cannot be achieved over the entire molding in this manner because the chemical reaction, which begins early in real-life polyurethane systems, relatively rapidly brings about an increase in viscosity and then plasticity, which means that pressure is not transferred to remote areas of the molding.

EP-A-0 206 100 describes a positive mold, which is initially held slightly further open during introduction of the reaction mixture into the mold cavity and is immediately thereafter advanced into the final position, wherein counterforce cylinders are withdrawn. Quite apart from the fact that this solution is complicated and elaborate and thus also costly, in particular with regard to the positive molds which are required, a further shortcoming is that, due to known production tolerances, exact dimensional stability of the moldings is not sufficiently reproducible.

EP-A-0 673 746 also involves the use of elaborate and costly positive molds, wherein one mold half is designed to be mobile against pretensioned spring elements. While it certainly is possible to exert holding pressure on the reaction mixture in this manner, reproducibly dimensionally accurate, industrial moldings cannot be obtained due to known process tolerances.

All processes which are based on requiring mold halves or parts thereof to be mobile relative to one another in the actual mold cavity zone, have the same problem of inadequately reproducible dimensional accuracy. This shortcoming is, however, unacceptable for industrial parts.

### SUMMARY OF THE INVENTION

Accordingly, the present invention provides a simple and cost-effective process with which it is possible under defined, reproducible production parameters to produce faultless and in particular thin-walled, large-area moldings for industrial applications, which molds exhibit shortcomings neither with regard to visual appearance, such as for example sink marks or pinholes, nor with regard to dimensional accuracy and dimensional stability.

These and other advantages and benefits of the present invention will be apparent from the Detailed Description of the Invention herein below.

### BRIEF DESCRIPTION OF THE FIGURES

The present invention will now be described for purposes of illustration and not limitation in conjunction with the figures, wherein:

FIG. 1 shows a plan view of an upper mold part in which overflow cavities are arranged;

FIG. 2 illustrates a cross-section through the mold, which is made of the upper mold part shown in FIG. 1 and the lower mold part shown in FIG. 3;

FIG. 3 depicts a plan view of a lower mold part, in which the runner is arranged;

FIG. 4 illustrates a cross-section through a mold with overflow cavities taking the form of individual chambers, wherein the overflow cavities are divided into two chambers by membranes;

FIG. 5 shows a plan view of an upper mold part with an overflow cavity taking the form of an annular channel;

FIG. 6 depicts a cross-section through the mold, which is made of the upper mold part shown in FIG. 5 and the lower mold part shown in FIG. 7; and

FIG. 7 shows a plan view of a lower mold part with an overflow cavity taking the form of an annular channel.

### DETAILED DESCRIPTION OF THE INVENTION

The present invention will now be described for purposes of illustration and not limitation. The invention relates to a process for the production of polyurethane moldings by the RIM process, in which at least one isocyanate component and at least one polyol component are delivered in metered manner into a mixing chamber, are mixed in the mixing chamber to form a polyurethane reaction mixture and the polyurethane reaction mixture is then discharged via a runner into the cavity of a mold, characterized in that a pressure is exerted on the polyurethane reaction mixture in the cavity by a pressure medium, which pressure is sufficiently high for defects, which arise by reactive and/or thermal shrinkage, and/or entrapped air pockets to be closed, wherein the pressure medium is introduced into at least one overflow cavity hydraulically connected with the cavity, and/or is introduced into the runner.

The process is distinguished in that one or more overflow cavities are assigned to the cavity, into which overflow cavities a pressure medium is injected as a secondary fluid with which a defined pressure is produced in the entire cavity, i.e. not only in the mold cavity and the overflow cavity but also in the gate area, which ensures that both sink marks, which arise due to thermal and/or chemical shrinkage, and entrapped air, such as voids and pinholes, are eliminated.

The pressure medium is generally injected substantially after completion of the shot, preferably immediately after completion of the shot of the polyurethane reaction mixture. It is, however, also possible to establish a time difference between the completion of the shot of the polyurethane reaction mixture and the beginning of injection of the pressure medium. One essential technical feature of the process is here that it is possible to adjust the level of cavity pressure in accordance with any desired time functions.

Pressure media which may be considered are not only gases, such as for example carbon dioxide, nitrogen or also air, but also liquids which are inert towards the reaction mixture, such as for example MESAMOLL from Bayer A G.

So that the cavity pressure produced by the pressure medium is maintained throughout the entire curing phase, the mold halves are preferably sealed relative to one another by a circumferential soft packing.

In a special development of the process, the pressure medium is injected through the surface of the polyurethane reaction mixture into the interior of the polyurethane reaction mixture. This is achieved by the outlet orifice of the injection valve opening approximately in the middle of the liquid, wherein the injection valve is, however, not opened until completion of the shot of the polyurethane reaction mixture.

This makes it possible to dispense with an additional soft packing, because the polyurethane reaction mixture surrounding the pressure medium is substantially more viscous than the pressure medium and so is quite sufficient to provide a seal between the mold halves which have been fitted together.

Injection of the pressure medium into the interior of the polyurethane reaction mixture provides the further advantage that uncontrolled penetration of pressure medium into the cavity is prevented.

The invention furthermore relates to an apparatus for the production of polyurethane moldings containing a mixing head with a mixing chamber and a mold with a cavity, which is hydraulically connected via a runner with the mixing head, characterized in that the cavity is hydraulically connected with at least one overflow cavity and at least one injection valve for injecting a pressure medium is arranged in the area of the overflow cavity and/or in that at least one injection valve for injecting a pressure medium is arranged in the area of the runner.

If recesses are provided within a molding, it is possible to use these also as overflow cavities and to arrange injection points therein for the pressure medium.

In a preferred embodiment, the overflow cavities take the form of individual chambers which are separate from one another. It is preferred here for every, or at least virtually every, individual chamber to be assigned its own injection valve. This is, however, not absolutely necessary for flat mold cavities. In this case, all the injection points may open into a common overflow cavity. In the case of three-dimensional moldings, however, overflow cavities taking the form of individual chambers are advantageous because this prevents pressure medium from escaping in uncontrolled manner into the mold cavity via the geodetically next higher injection site.

In an alternative embodiment, the overflow cavity takes the form of an annular channel around the mold cavity, by which means a homogeneous pressure distribution may be achieved even with thin-walled moldings. Because the annular channel is only filled relatively late during filling of the cavity with polyurethane reaction mixture and the mixture remains hydrostatic for the longest in the core zone of the annular channel, the pressure medium injected at the head end can very rapidly develop a pressure potential around the entire cavity, from which the pressure waves may then reach the entire molding.

The overflow cavities are preferably arranged above the adjoining cavity, in particular above the geodetically highest point of the cavity, such that uncontrolled transfer of pressure medium into the cavity is avoided. To this end, however, the particular quantity of pressure medium and the volume of the overflow cavity must be adjusted to one another.

In a preferred embodiment, a membrane is arranged in the overflow cavity, which membrane divides the overflow cavity into two chambers and ensures that the polyurethane reaction mixture and the pressure medium remain separate from one another. In this way, it is ensured that the pressure medium and the polyurethane reaction mixture cannot come into direct contact and contamination of the polyurethane reaction mixture is avoided.

In another preferred embodiment the mixing head additionally contains a cleaning piston, wherein an injection valve is additionally arranged in the cleaning piston.

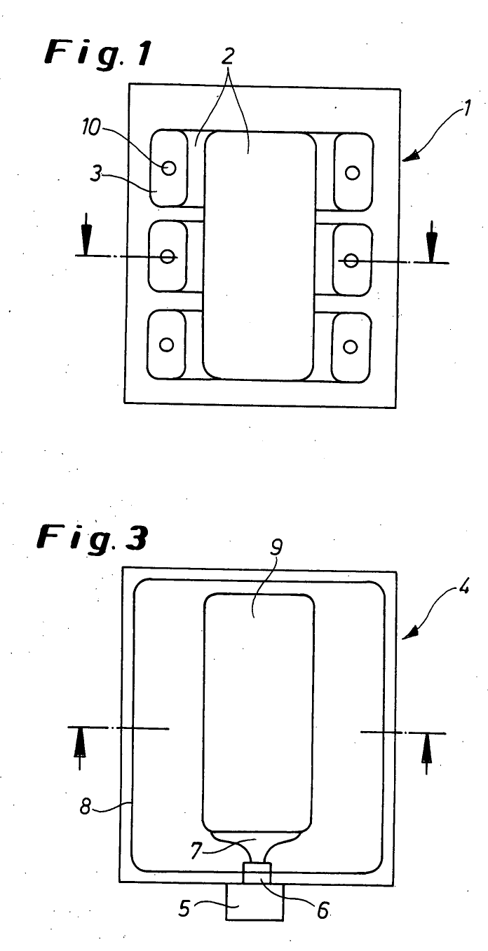

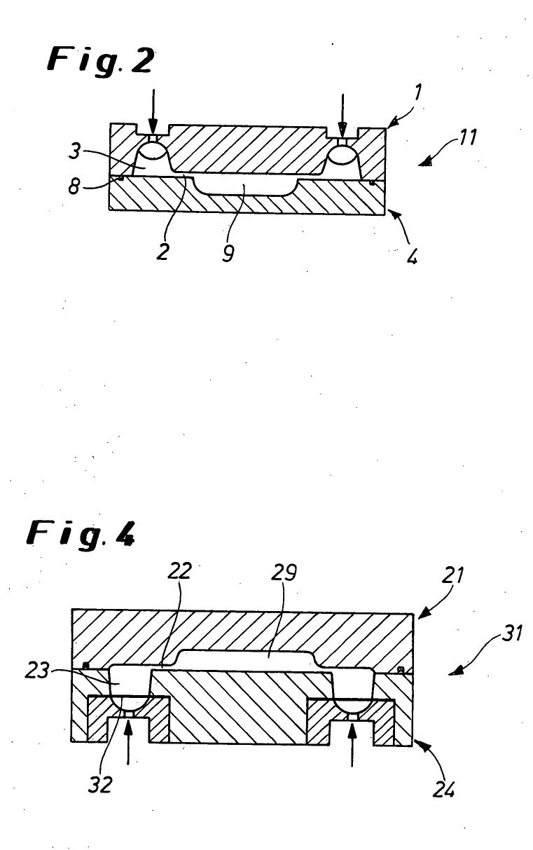

Referring to FIG. 1 showing a plan view of an upper mold part 1, the mold part 1 contains slight indentations 2, which form the upper boundary of the cavity 9 (shown in FIGS. 2 and 3) and by which the cavity is hydraulically connected with the overflow cavities 3 arranged to the side of the indentation 2. All the overflow cavities 3 have orifices 10, in which injection valves (not shown) for injecting the pressure medium are arranged.

FIG. 3 shows a lower mold part 4 which fits therewith. The lower mold part contains a cavity 9. The cavity 9 is hydraulically connected via the runner 7 with the outlet channel 6 from the mixing head 5. A soft packing 8 is arranged in a circumferential groove in the lower mold part 4, by means of which packing the upper and lower mold parts are sealed relative to one another.

FIG. 2 shows a cross-section through the mold 11 which is made of the upper mold half 1 and the lower mold half 4. During the shot, the polyurethane reaction mixture penetrates into the cavity 9 and fills it and then passes through the gaps, which are delimited by the indentations 2 in the upper mold half and the surface of the lower mold half, into the overflow cavities 3. Directly on completion of the shot or after a set time difference, the gaseous or liquid pressure medium is then injected through the orifices 10 (shown in FIG. 2 by arrows) into the overflow cavities.

The overflow cavities 3 are here arranged geodetically above the cavity, such that uncontrolled transfer of pressure medium into the cavity 9 is avoided. A pre-requisite in this connection, however, is that the particular quantity of pressure medium and the volume of the overflow cavities 3 are adjusted to one another.

Because the overflow cavities 3 are arranged uniformly around the mold cavity 9 and each of the overflow cavities is equipped with its own opening 10 for injecting the pressure medium, it is possible to build up a cavity pressure over the entire cavity 9 even if the polyurethane reaction mixture is highly reactive and reacts and cures very rapidly.

FIG. 4 shows a mold 31 containing an upper mold half 21 and a lower mold half 24. The mold cavity 29 is here arranged in the upper mold half 21. The mold 31 furthermore contains overflow cavities 23, which are arranged geodetically below the cavity 29 and which are hydraulically connected with the cavity 29 via gaps 22, which are formed between the upper mold part 21 and the lower mold part 24. The pressure medium may be injected (indicated as arrows) into the overflow cavities 23 via the orifices arranged in the overflow cavities. The overflow cavities 23 furthermore contain membranes 32, which divide the overflow cavities horizontally into two chambers and separate the pressure medium from the polyurethane reaction mixture. If the overflow cavities are pressurized with the pressure medium after completion of the shot, the membranes flex upwards and expel the polyurethane reaction mixture from the overflow cavity into the cavity 29 such that an adjustable pressure is obtained therein. The pressure to which the overflow cavities 23 are pressurized with the pressure medium may here be kept constant or alternatively varied over time. As a direct consequence, it is possible in this manner, depending on the application, to establish virtually at will a pressure in the mold cavity 29 which is constant or varies over time.

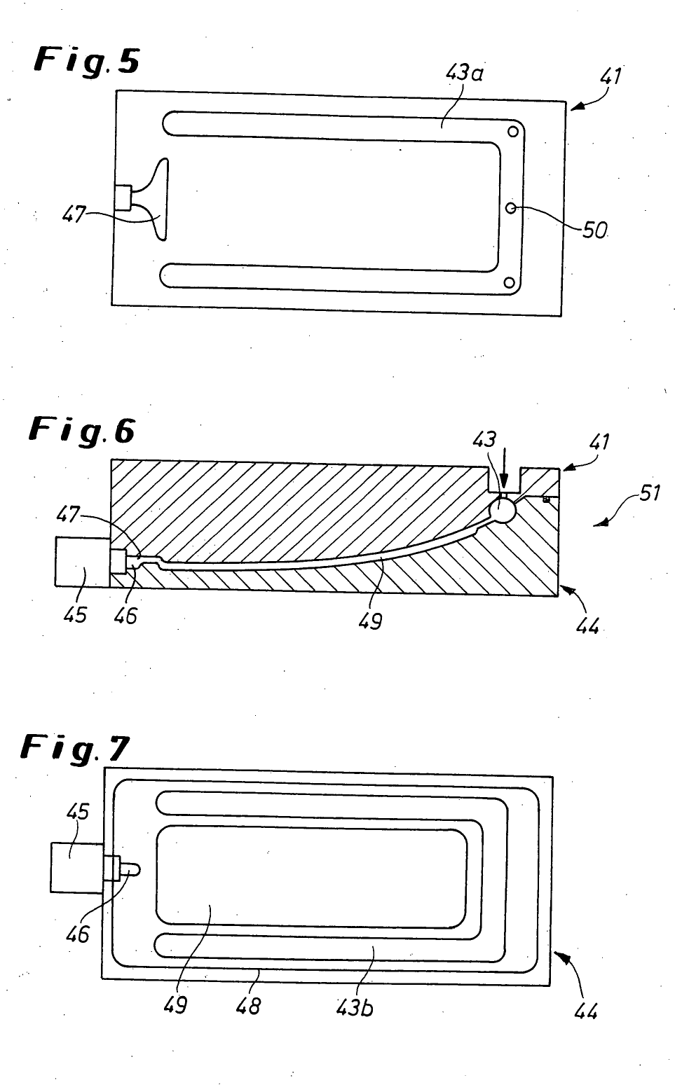

FIG. 5 shows a plan view of an upper mold part 41. The mold part 41 has a channel 43a which runs around three sides of the mold part, said channel forming the upper part of the overflow cavity. Orifices 50 are here arranged in the circumferential channel 43a, through which orifices the pressure medium can pass into the overflow cavity in the assembled mold . The upper mold part 41 furthermore comprises a runner 47, through which the polyurethane reaction mixture passes into the cavity 49 (shown in FIGS. 6 and 7).

FIG. 7 shows a lower mold part 44 which fits therewith. The lower mold part contains a cavity 49. The cavity 49 is hydraulically connected via the runner 47 in the upper mold part 41 with the outlet channel 46 from the mixing head 45. A soft packing 48 is arranged in a circumferential groove in the lower mold part 44, by which the upper and lower mould parts are sealed relative to one another. The lower mold part 44 additionally comprises a channel 43b which runs around three sides of the mould part, said channel forming the lower part of the overflow cavity. If the upper mold part 41 and the lower mold part 44 are fitted one on top of the other, the circumferential grooves 43a and 43b lie one above the other and delimit the overflow cavity which runs around three sides of the mold.

FIG. 6 shows a cross-section through the mold 51 which is made of the upper mold half 41 and the lower mold half 44. During the shot, the polyurethane reaction mixture flows out of the outlet channel 46 of the mixing head 45 into the runner 47 and then penetrates into the cavity 49 and fills the latter and then passes through the gaps between the upper mold half 41 and the lower mold half 44 into the overflow cavity 43.

Directly on completion of the shot or after a set time difference, the gaseous or liquid pressure medium is then injected through the orifices 50 (shown in FIG. 6 by arrows) into the overflow cavity. Because the orifices 50 (shown in FIG. 5), through which the pressure medium may be injected into the overflow cavity in the assembled mold 51, are arranged in the upper mold part 41 and above the geodetically highest point of the cavity 49, the pressure medium cannot enter the cavity 49.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A process for the production of polyurethane moldings by the reaction-injection-molding process, comprising
delivering at least one isocyanate component and at least one polyol component in metered manner into a mixing chamber;
mixing the at least one isocyanate component and the at least one polyol component in the mixing chamber to form a polyurethane reaction mixture;
discharging the polyurethane reaction mixture via a runner into a cavity of a mold; and
exerting a pressure on the polyurethane reaction mixture in the cavity by a pressure medium which is sufficiently high to close defects arising by reactive and/or thermal shrinkage, and/or entrapped air pockets,
wherein the pressure medium is introduced into at least one overflow cavity hydraulically connected with the cavity, and/or is introduced into the runner.

2. The process according to claim 1, wherein the pressure medium is injected approximately after completion of the shot of the polyurethane reaction mixture and wherein the time difference between the injection of the pressure medium and the completion of the shot of the polyurethane reaction mixture is adjustable.

3. The process according to claim 1, wherein the pressure level of the cavity pressure produced by the pressure medium is adjustable throughout the entire curing phase of the polyurethane reaction mixture.

4. The process according to claim 1, wherein the pressure medium is chosen from carbon dioxide, nitrogen, air and a liquid which is inert towards the polyurethane reaction mixture.

5. The process according to claim 1, wherein the pressure medium is injected through the surface of the polyurethane reaction mixture into the interior of the polyurethane reaction mixture.

6. An apparatus for the production of polyurethane moldings containing a mixing head comprising a mixing chamber and a mold having a cavity hydraulically connected with the mixing head via a runner, wherein the cavity is hydraulically connected with at least one overflow cavity and at least one injection valve for injecting a pressure medium is arranged in a zone of the overflow cavity and/or wherein at least one injection valve for injecting a pressure medium is arranged in an area of the runner.

7. The apparatus according to claim 6, wherein the overflow cavity is arranged as an annular channel around the cavity.

8. The apparatus according to claim 6, wherein the overflow cavities are arranged as individual chambers around the cavity.

9. The apparatus according to claim 6, wherein the overflow cavity is arranged above the adjoining cavity.

10. The apparatus according to claim 6, wherein the overflow cavity is arranged above the geodetically highest point of the cavity.

11. The apparatus according to claims 6, wherein a membrane is arranged in the overflow cavity, which membrane divides the overflow cavity into two chambers and prevents the pressure medium from entering the cavity.

12. The apparatus according to claim 6, wherein the mixing head additionally contains a cleaning piston and wherein an injection valve is arranged in the cleaning piston.
